(19) United States
(12) Patent Application Publication
(10) Pub. No.: US 2007/0029437 A1
(43) Pub. Date: Feb. 8, 2007

(54) FILM LOADING ARRANGEMENT FOR LAMINATOR

(75) Inventors: Ervin Gaines, Crown Point, IN (US); Roger Hamblen, North York, ON (CA); Yang-Pioung Kim, Seoul (KR)

Correspondence Address: MICHAEL BEST & FRIEDRICH, LLP, 100 E WISCONSIN AVENUE, MILWAUKEE, WI, 53202, US

(73) Assignee: GENERAL BINDING CORPORATION, Northbrook, IL (US)

(21) Appl. No.: 11/462,498

(22) Filed: Aug. 4, 2006

Related U.S. Application Data
(60) Provisional application No. 60/705,895, filed on Aug. 5, 2005.

(51) Int. Cl. B65H 18/04; B32B 37/00

(52) U.S. Cl. 242/599.3; 156/580

(57) ABSTRACT

A film loading arrangement simplifies the film loading process for a user and prevents the improper loading of a laminate film roll into a laminating machine. The laminating machine includes a female support unit configured to receive a first end of the laminate film roll to properly position the roll in the laminating machine, and a male support unit configured to be received in the second end of the laminate film roll to properly position the roll in the laminating machine. A male coupling structure of the roll is received in the female support unit and a female coupling structure of the roll receives the male support unit. The laminating machine further includes a tensioning mechanism for adjusting the force required to unroll laminating film from the supported roll.

### RELATED APPLICATIONS

This application claims priority to U.S. Provisional Patent Application No. 60/705,895 filed Aug. 5, 2005, the entire content of which is hereby incorporated by reference.

### FIELD OF THE INVENTION

The invention relates to table top laminators, and, more particularly to an arrangement for ensuring proper and easy loading of rolls of laminating film for use in such laminators, and an arrangement for tensioning such rolls as they are fed into the laminator.

### BACKGROUND OF THE INVENTION

Laminating machines (or laminators) are used to apply a laminate film to a sheet material, such as paper. The film coats the upper and/or lower surfaces of the sheet material, and, thus, protects the sheet material by shielding the sheet material from external elements. Some laminators use discrete pre-cut films of a particular size to laminate a sheet material. Alternately, the film used in other laminators is supplied on a roll that is unwound as the film is led into the laminator and cut to the appropriate size after the sheet has been laminated. With these roll-type laminators, a significant amount of film may be supplied before the user needs to reload the film. Typically, two rolls are utilized by the laminator to provide an upper film and a lower film for disposal on an upper surface and lower surface of the sheet material, respectively. In this way, the sheet material is completely enclosed and protected by the films.

The laminate film typically comprises a substrate and an adhesive layer, which is disposed on one side of the substrate. The adhesive may be a pressure sensitive adhesive or a thermal adhesive. In the case of pressure sensitive adhesives, the sheet material and film are fed into the laminator and a compression force is applied to the sheet material and film combination to activate the adhesive and adhere the film to the sheet material. Usually, this force is applied by a roller or similar suitable structure. In the case of films having a thermal adhesive, heat is applied to the film to activate the adhesive and adhere the film to the sheet material. Often, the heat is supplied through a heating roller that may also apply a compression force on the film and sheet material combination.

Considering that the adhesive is disposed on only one side of the film, it is essential that the film be loaded correctly into the laminator, i.e., such that as the film is fed into the laminator, the adhesive is disposed between the substrate and the sheet material. If the film is loaded incorrectly, the adhesive will not be disposed adjacent to the sheet material, and, thus, the film will not adhere to the sheet material. Furthermore, loading the film incorrectly may cause significant damage to the interior of the machine because the adhesive may adhere to components such as the roller. Such damage may necessitate costly and/or time consuming repairs and cleaning of the laminator.

In current laminators, it is difficult for users to determine how the film should be loaded because the rolls of film may physically be loaded in either direction, the machines lack adequate instruction to assist the user, or the user fails to follow provided instructions for loading the film. Thus, it is common for users to incorrectly load the rolls of film and damage the laminator. Furthermore, when using laminators having films to laminate both the upper surface and the lower surface of a sheet material, it can be difficult to mount the upper roll and the lower roll such that they are properly aligned with the sheet material and each other

### BRIEF SUMMARY OF THE INVENTION

The invention provides a film loading arrangement that simplifies the film loading process for a user and prevents the improper loading of a laminate film roll into a laminator. The invention provides components that allow the laminate roll of film to be loaded in the correct orientation by providing differing connection structures on each end of the laminate film roll. The differing connection structures are received by respective receiving structures on the laminator. Each connection structure is compatible with only one of the receiving structures such that when the connection structures are attached to the roll, the film can be loaded in only one direction, i.e., correctly. Therefore, the user can properly load a laminate film roll and avoid damaging the laminator as a result of improper film loading.

In one embodiment, the invention provides a laminate film roll including rolled laminate film, a first end having a female coupling structure to facilitate loading of the laminate film roll in a proper orientation in a laminating machine, and a second end having a male coupling structure to facilitate loading of the laminate film roll in a proper orientation in the laminating machine.

In another embodiment, the invention provides a laminating machine configured to support a roll of laminate film having first and second ends. The laminating machine includes a female support unit configured to receive a first end of the laminate film roll to properly position the roll in the laminating machine, and a male support unit configured to be received in the second end of the laminate film roll to properly position the roll in the laminating machine.

Furthermore, the invention provides a friction force adjustment mechanism that permits the adjustment of the amount of friction force that is applied to the roll of film when it is mounted in the laminator. Thus, the friction force adjustment mechanism controls the amount of force needed to unwind the roll of film and provides for a relatively consistent tension between the laminator and the roll. The friction force adjustment mechanism prevents undesired over-rolling of the film roll during the laminating process and enables the film to be fed into the laminator at a relatively controlled rate.

The film loading apparatus comprises a male support unit, a male coupling structure, and a fixed female support unit. The male support unit and the male coupling structure may be coupled to respective ends of the laminate film roll. The fixed female support unit is attached to an interior surface of the laminator and comprises a seat for receiving the male coupling structure. A receiving hole is disposed on an interior surface of the laminator opposing the fixed female support unit. The receiving hole receives an end of the male support unit. The male support unit may have a structure that permits the unit to receive any one of a plurality of different sizes of laminate rolls. When the laminate film is loaded into the laminator, one end of the roll is supported by the male support unit and the other end is supported by the male coupling structure resting on the fixed female support unit.

### BRIEF DESCRIPTION OF THE DRAWINGS

FIG. 1 is a perspective view of a laminating machine with a film loading arrangement in accordance with teachings of the invention;

FIG. 1A is an enlarged fragmentary view of a female support structure and tensioning mechanism of FIG. 1 constructed in accordance with teachings of the invention;

FIG. 2 is a fragmentary cross-sectional view of the laminating machine and film loading arrangement shown in FIG. 1; and

FIG. 3 is an exploded view of the film loading arrangement shown in FIGS. 1 and 2.

### DETAILED DESCRIPTION OF THE INVENTION

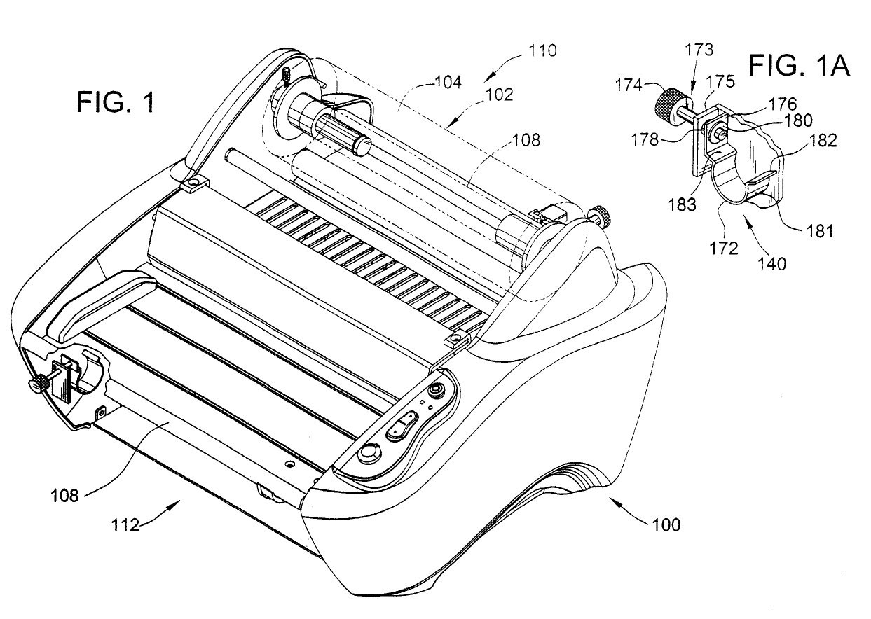

Turning to the drawings, a laminating machine (or laminator) 100 is shown in FIG 1. The laminator 100 is used to adhere a laminate film 104 to a sheet material, such as paper In a laminator 100 of the type illustrated, the laminate film 104 is supplied to the laminator 100 from one or more laminate film rolls 102, the laminate film 104 itself being wound around a tube 106. The laminator 100 receives the sheet material (not shown) near the front 108 of the laminator 100. The sheet material is fed into the laminator and combined with one or more laminate films 104 to provide a protective coating to an upper and/or lower surface of the sheet material. The combined sheet material and laminate film(s) 104 typically proceed between a first roller and a flat surface or a second roller (not shown) to activate the lamination. While the actual lamination process itself is not shown in the drawings, the lamination process is well known to those of skill in the art.

The upper laminate film may be supplied from a laminate roll 102 disposed in an upper laminate film mounting area 110 of the laminator 100, while the lower laminate film (not shown) may be supplied from a laminate roll disposed in a lower laminate film mounting area 112. As the laminate film 104 is pulled into the laminator 100 to laminate a sheet material, the laminate film 104 is unwound from the roll 102, forcing the roll 102 to rotate.

The laminate film roll 102 is mounted to the laminator 100 in the upper and/or lower film mounting area(s) 110, 112 via a film loading arrangement. In accordance with an aspect of the invention, the film loading arrangement permits the laminate film roll 102 to be loaded in only one position, i.e., the arrangement prevents the laminate film roll 102 from being loaded improperly. In accordance with another aspect of the invention, the arrangement enables the laminate film 104 to be steadily unwound from the roll 102 as the film feeds into the laminator 100.

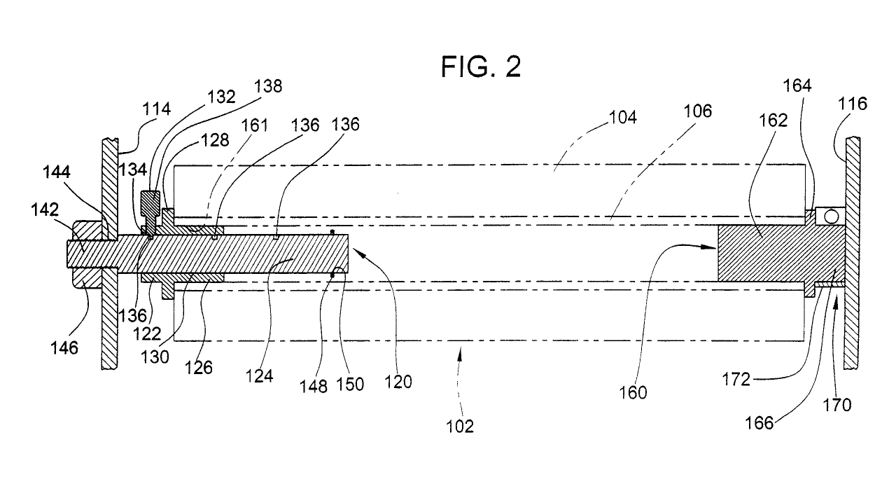

In order to enable the film roll 102 to be loaded in the laminator 100 in only one relative position, the film roll 102 and the laminator 100 include mating structures that differ from one side to the other. More specifically, in the illustrated embodiment, the film roll 102 includes a male coupling structure 160 at one end, and a female mounting structure 161 at the other. The female mounting structure 161 may be formed by the end of the tube 106 itself, as shown in FIG. 2, or by an alternate structure, such as an insert. The laminate film mounting area 100, 112 of the laminator 100 includes a corresponding male support unit 120 extending from an interior facing surface (such as 114) of the laminator 100 for receipt in the female mounting structure 161 of the film roll 102, and a female fixed female support unit 170 along an opposing interior facing surface (such as 116) of the laminator 100 for receipt of the male coupling structure 160 of the film roll 102.

To minimize feeding difficulties resulting from skew in the film, the male support unit 120 preferably comprises structure to maintain the film roll 102 in a set lateral position within the machine 100. In the illustrated embodiment, the male support unit 120 comprises a cylindrical member 124 that is received within the female mounting structure 161 at the end of the film roll 102, and a radially extending flange 128. In this way, the radially extending flange 128 maintains the relative lateral position of the film roll 102 during usage. It will be noted that the male support unit 120 may be structured such that the film roll 102 rotates on or with the cylindrical member 124, or the radially extending flange 128 may further comprise a cylindrical insertion portion 126 disposed within the film roll 102. The cylindrical member 124 may be of any appropriate size so long as it is of a length adequate to support the film roll 102.

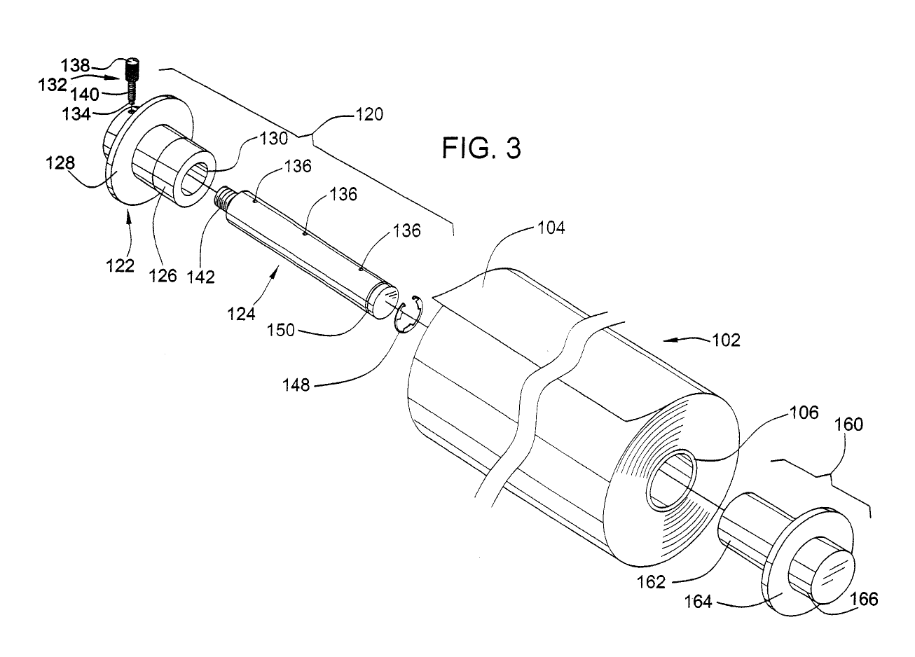

When laminating sheet materials with different widths on a single laminator 100, it may be desirable for the loading arrangement of the laminator to have the capability to accommodate a plurality of sizes of laminate film rolls. Accordingly, the male support unit 120 is preferably adjustable to allow the support unit 120 to accommodate laminate film rolls 102 having varying sizes. In the illustrated embodiment of FIGS. 2 and 3, the radially extending flange 128 and cylindrical insertion portion 126 comprise a movable body 122 that is slidably mounted along the cylindrical member 124 by a receiving hole 130. In this way, the movable body 122 may slide on the cylindrical member 124 to a desired location along the cylindrical member 124. To prevent the movable body 122 from sliding off of the cylindrical member 124, the cylindrical member 124 may comprise a retaining structure, such as a retainer ring 148 disposed within a ring seat 150, although any suitable retaining structure may be provided.

In order to secure the movable body 122 with respect to the cylindrical member 124, the movable body 122 may have a locking mechanism 132 that prevents or minimizes relative axial movement of the movable body 122 and the cylindrical member 124. While any appropriate locking mechanism may be utilized, the locking mechanism 132 illustrated includes a locking protrusion 134 that may be received a locking hole 136 on the cylindrical member 124. The cylindrical member 124 may have one or more of these locking holes 136 such that the movable body 122 can be secured at any one of a plurality of locations along the length of the cylindrical member 124 depending on the size of the film 102.

While any number of locking holes 136 may be provided, the locking holes 136 are disposed at precise locations for rolls 102 of a given size such that they assist the user to properly align the upper and lower rolls of laminate film with each other and the sheet material. Thus, by deploying the locking protrusion 134 into a locking hole 136 when the insertion portion 126 of the movable body 122 is fully inserted into the tube 106, the roll 102 is disposed in a precise position within the laminator 100 and with respect to any additional roll 102

The locking protrusion 134 may be selectively moved in and out of the locking hole(s) 136 by any arrangement. In the illustrated embodiment, a threaded portion 140 is provided along the shaft of the locking protrusion 134 and a knob 138 is provided for manipulating the protrusion into or out of the locking hole(s) 136. It will be appreciated that the movable body 122 of the male support unit 120 may alternately be fixed to the cylindrical member 124 for applications with a specific sized laminate film roll 102.

Any appropriate structure may be provided to couple the cylindrical member 124 to the laminator 100. For example, the cylindrical member 124 may comprise a threaded end 142 that may be received in a support hole 144 within an internally facing surface 114 of the laminator 100. The support hole 144 may be threaded and/or a threaded locking nut 146 may be provided to engage and secure the threaded end 142 of the cylindrical member 124 to the laminator 100.

To ensure that the film roll 102 is properly loaded in the laminator 100, the film roll 102 is preferably supplied to the user with the male coupling structure 160 extending outwardly from the proper end of the film roll 102. For example, the male coupling structure 160 is preferably formed as part of the tube 106 or is substantially fixed to the tube 106 (including, but not limited to, gluing the male coupling structure 160 to the tube 106) such that the user could not inadvertently remove and improperly replace the male coupling structure 160. It will be appreciated, however, that the male coupling structure 160 may be in the form of a removable insert that may be placed within a film roll 102 prior to use. If the male coupling structure 160 is a separate component from the tube 106, then the tube 106 or laminate film roll 102 may have a feature or marking that clearly indicates which end of the tube the male coupling structure 160 should be coupled thereto.

As shown in FIGS. 2 and 3, the male coupling structure 160 may comprise an insertion portion 162 for disposal within the hollow interior of the film roll 102, and a protruding male support portion 166 for receipt with in the fixed female support unit 170. As with the male support unit 120, the male coupling structure 160 may further comprise a lateral restrictor, such as a radially extending flange 164, to limit the lateral movement of the film roll 102 within the laminator 100 and restrict the extent that the insertion portion 162 may enter the tube 106. As described in more detail below, the support portion 166 is coupled to the fixed female support unit 170 when the roll of film 102 is loaded in the laminator 100.

When both upper and lower films are utilized in the lamination process, it is desirable for the upper and lower film rolls 102 to be placed in alignment in the laminator 100. This alignment is automatically accomplished by the film loading arrangement with rolls 102 that span the upper and lower film mounting areas 110, 112. When smaller rolls of film 102 are utilized, however, ensuring proper alignment becomes more complex in that, for example, both rolls 102 must be aligned with each other to the left, right, or center, or at some other position therebetween. While alternate arrangements are considered within the scope of the invention, in a preferred embodiment, both film rolls 102 are aligned in the center of the respective film mounting area 110, 112. It will thus be appreciated that the support portion 160 of the male coupling structure 160 extends further outward from the roll 102 to dispose the roll 102 a greater distance from the female support unit 170 and the interior facing surface 116 i.e., to center the roll 102 in the film mounting area 110, 112. Similarly, at the opposite end of the roll 102, the movable body 122 may be disposed at a position along the cylindrical member 124 that disposes the roll 102 a greater distance from the interior facing surface 114, the locking protrusion 134 engaging one of the locking holes 136 at a preset position based upon the width of the roll 102. In this way, the roll 102 may be centered within the film mounting area 110, 112.

The fixed female support unit 170 is disposed on an interior facing surface 116 (or a suitable support plate coupled to interior facing surface 116), of the laminator 100 opposing the surface 114 with the support hole 144. The fixed female support unit 170 has a structure suitable to receive the support portion 166 of the male coupling structure 160 and permit the support portion 166 to rotate within the fixed female support unit 170. In order to provide a desirable tensioning of the film as it is unrolled from the film roll 102, the fixed female support unit 170 further comprises a tensioning arrangement that allows the fixed female support unit 170 to be adjusted to increase and decrease the force required to rotate the laminate film roll 102.

As shown in FIG. 1A, the fixed female support unit 170 comprises a seat 172 that preferably comprises a generally arcuate shape. The generally arcuate shape of the seat 172 presents a cradle that accommodates the cylindrical outer surface of the support portion 166 of the male coupling structure 160 which is disposed in the seat 172 when the laminate film roll 102 is loaded in the laminator 100. The seat 172 may be constructed of a material that provides the seat 172 with elastic properties, such as spring steel. The seat 172, however, may he constructed of any suitable material.

It is desirable for the laminate film roll 102 to be restricted by a certain amount of force (such as a friction force) to prevent over-rolling as the laminate film 104 is pulled into the laminator 100. Over-rolling may occur, for example, when the laminator 100 is pulling the film 104 if the pulling force is not steady or when the laminator 100 stops pulling the film 104 and the momentum of the roll 102 causes it to continue to rotate. If a sufficient resisting force is not applied to the roll 102, then the momentum of the roll 102 may undesirably result in excess unwound film 104 and a lack of tension between the laminate roll 102 and the laminator 100. This over-rolling and/or lack of tension can cause fluctuations in the feed rate of the laminate film 104 into the laminator 100 and cause fluctuations in the quality of the laminated sheet material.

The film loading arrangement has a structure that permits a user to adjust the amount of force needed to rotate the laminate film roll 102. In accordance with teachings of the invention, the fixed female support unit 170 may comprise a friction force adjustment mechanism 173. The friction force adjustment mechanism 173 allows the user to adjust the diameter of the seat 172, i.e., the size of the cradle in which the male coupling structure 160 is received thereby adjusting the amount of friction between the male coupling structure 160 and the seat 172.

Referring to FIG. 1A, one end 181 of the seat 172 is coupled to laminator 100 near edge 182, while the opposite end 183 of the seat 172 is cantilevered from the first, secured end 181. The friction force adjustment mechanism 173 is coupled to a flange 176 at end 183 of the seat 172 to allow for adjustment of end 183 relative to fixed end 181. The friction force adjustment mechanism 173 comprises a thumb screw 174 that extends through a fixed plate 175, a bolt hole 178 and one or more washers 180 that retain the thumb screw 174 to the flange 176.

When the support portion 166 of the male coupling structure 160 is disposed on the seat 172, the thumb screw 174 may be rotated to compress the seat 172 toward the male coupling structure 160 (i.e., toward the front 108 of the laminator 100 if adjusting the friction force adjustment mechanism for the upper laminate roll). The coupled end 181 of the seat 172 supports the laminate film roll 102 and resists the force applied by the adjustment mechanism 173.

The seat 172 elastically deforms such that the diameter of the seat 172 decreases in at least one direction to create a compression and friction force on the support portion 166 of the male coupling structure 160. As the thumb screw 174 continues to be tightened, the compressive force applied to the support portion 166 of the male coupling structure 160 increases. During the lamination process, the laminate film roll 102 is forcibly rotated (i.e., the male coupling structure 160 rotates within the seat 172 of the fixed female support unit 170) to create a tension in the film 104 as the film 104 is pulled into the laminator. In order for the laminate film roll 102 to rotate, the force applied must be sufficient to overcome the friction force created by the compression of the seat 172 against the support portion 166 of the male coupling structure 160. Thus, the friction force adjustment mechanism 173 prevents over-rolling of the film and enables tension to be maintained in the film 104 between the laminator 100 and the roll 102 that can help to prevent quality fluctuations in a laminated sheet.

The following example further illustrates the invention but, of course, should not be construed as in any way limiting its scope. In order to load a laminate film roll 102, the male coupling structure 160 is inserted into a designated end of a laminate film roll 102. As described above, to avoid user error, the roll 102 may preferably be coupled to the male coupling structure 160 when provided to the user or the male coupling structure 160 may be formed as part of the laminate film roll 102. The male support unit 120 is attached to the laminator 100 by screwing the cylindrical member 124, with the movable body 122 coupled thereto, into the support hole 144 of the laminator 100. Alternately, in certain embodiments, the user may attach the male support unit 120 to the laminate film roll 102 before attaching the male support unit 120 into the laminator 100.

The user loads the laminate film roll 102 into the laminator 100 by moving the laminate film roll 102 toward the cylindrical member 124 such that the cylindrical member 124 is inserted into the female mounting structure 161. The movable body 122 is then moved toward the laminate film roll 102 such that a portion of the movable body 122 is inserted into the tube 106. The radially extending flange 128 on the movable body 122 restricts the extent to which the movable body 122 may be inserted into the tube 106. The locking mechanism 132 may then be used to lower the locking protrusion 134 into a locking hole 136 of the cylindrical member 124. This secures the movable body 122 with respect to the cylindrical member 124, thus preventing any lateral movement of the roll 102.

As the cylindrical member 124 is inserted into the laminate film roll 102, the opposing end of the laminate film roll 102 may begin to be lowered toward the laminator 100 until the male coupling structure 160 rests within the seat 172 of the fixed female support unit 170. The thumb screw 174 may then be rotated to increase the amount of tension necessary to rotate the roll 102 and unwind the film 104.

One of ordinary skill in the art will appreciate that the upper and lower laminate film rolls may be loaded in a substantially similar fashion, as the film loading arrangements for the upper and lower laminate films may be substantially the same or identical to one another. The male support unit, male coupling structure, and fixed female support unit for the lower laminate film roll, however, may respectively be disposed in a reverse orientation than the respective components for the upper roll (see FIG. 1, for example). The reverse orientation may be necessary, for example, because for certain laminators the adhesive on the lower roll of film should be facing upward as the film enters the laminator so the film can be adhered to the lower surface of a sheet material, while the adhesive on the upper roll of film should be facing downward as the film enters the laminator to be adhered to the upper surface of a sheet material.

It will be appreciated that the film loading apparatus may be used with rolls of thermal adhesive films or pressure sensitive adhesive films. Additionally, the film loading apparatus may be utilized on laminators capable of receiving one or more rolls of laminate film. A film loading arrangement that prevents improper loading of a laminate film roll into a laminator by utilizing one or more features that allow the laminate film roll to be loaded in only the correct orientation is disclosed herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A laminate film roll comprising:
rolled laminate film;
a first end having a female coupling structure to facilitate loading of the laminate film roll in a proper orientation in a laminating machine; and
a second end having a male coupling structure to facilitate loading of the laminate film roll in a proper orientation in the laminating machine.

2. The laminate film roll of claim 1, further comprising a tube about which the laminate film is rolled:
wherein the female and male coupling structures are inserted into the tube at the respective first and second ends.

3. The laminate film roll of claim 2, wherein each coupling structure includes a flange that limits the insertion of the coupling structure into the tube.

4. The laminate film roll of claim 1, wherein the female coupling structure includes an aperture for receiving a male support member coupled to the laminating machine.

5. The laminate film roll of claim 4, wherein the female coupling structure includes a locking mechanism operable to secure the female coupling structure to the male support member.

6. The laminate film roll of claim 5, wherein the locking mechanism is operable to secure the female coupling structure to the male support member at one of a plurality of locations along the male support member.

7. The laminate film roll of claim 5, wherein the locking mechanism includes a protrusion configured to be received in an aperture in the male support member.

8. The laminate film roll of claim 7, wherein the male support member includes a plurality of spaced apart apertures configured to receive the protrusion of the locking mechanism.

9. A laminating machine configured to support a roll of laminate film having first and second ends, the laminating machine comprising:
a female support unit configured to receive a first end of the laminate film roll to properly position the roll in the laminating machine; and
a male support unit configured to be received in the second end of the laminate film roll to properly position the roll in the laminating machine.

10. The laminating machine of claim 9, wherein the female support unit is configured to receive a male coupling structure coupled with the first end of the roll of laminate film.

11. The laminating machine of claim 10, wherein the male coupling structure is inserted into the first end of the roll of laminate film.

12. The laminating machine of claim 9, wherein the male support unit is received in a female coupling structure coupled with the second end of the roll of laminate film.

13. The laminating machine of claim 12, wherein the male support unit is received in an aperture in the female coupling structure.

14. The laminating machine of claim 12, wherein the female coupling structure includes a locking mechanism operable to secure the female coupling structure to the male support unit.

15. The laminating machine of claim 14, wherein the male support unit includes an aperture, and wherein the locking mechanism includes a projection configured to be received in the aperture in the male support unit.

16. The laminating machine of claim 14, wherein the locking mechanism is operable to secure the female coupling structure to the male support unit at one of a plurality of locations along the male support unit.

17. The laminating machine of claim 9, wherein the female support unit includes a friction force adjustment mechanism for adjusting a friction force exerted on the roll of laminate film.

18. The laminating machine of claim 17, wherein the friction force adjustment mechanism includes a screw.

19. The laminating machine of claim 9, wherein the female support unit includes a generally arcuate seat for receiving the first end of the roll of laminate film.

20. The laminating machine of claim 9, wherein the male support unit includes a generally cylindrical member configured to be received in the second end of the roll of laminate film.

21. An apparatus comprising:
a laminator having a sidewall with an inner surface, said side wall having a support hole therein, said laminator having an opposite sidewall with an inner surface;
a film roll having a paper tube with a hole therein;
a movable support unit provided at a predetermined position on said inner surface of said sidewall of said laminator, said movable support unit comprising:
a cylindrical body having a plurality of locking holes provided on an outer surface thereof, said cylindrical body having an external thread formed on a first end thereof, said external thread tightened into said support hole formed on said sidewall of said laminator, said cylindrical body having a ring seat groove formed on an outer surface of a second end thereof so as to receive therein a retainer ring;
a movable body fitted over said outer surface of said cylindrical body, said movable body having a receiving hole axially formed therein so as to allow said cylindrical body to pass therethrough, said movable body having a stopper and a screw hole provided at predetermined positions on an outer surface thereof; and
a hand-operated adjusting screw having an external thread, said adjusting screw tightened into said screw hole of said movable body, said hand-operated adjusting screw having a locking protrusion provided on a first end thereof, said hand-operated adjusting screw having a knob provided on a second end;
a fixed support unit provided at a predetermined position on said inner surface of said opposite sidewall of said laminator, said fixed support unit comprising:
a support plate with a bolt hole provided at a predetermined position thereon;
an arc-shaped elastic seat coupled at a first end thereof to an inner surface of said support plate so as to support therein an end of said paper tube of said film roll said elastic seat having a through hole provided on a second end thereof; and
an adjusting bolt coupled at an end thereof to said second end of said arc-shaped elastic seat said adjusting bolt being tightened into said bolt hole of said support plate, said end of the adjusting bolt having a pair of washers fitted thereover and around both sides of said through hole of said arc-shaped elastic seat so that said arc-shaped elastic seat is fastened to said end of the adjusting bolt; and
an insert support unit having a first end and a second end and an outer surface, said insert support unit comprising:
an insert part provided on said first end of said insert support unit, said insert part insertable into said hole in said paper tube of said film roll;
a stopper provided at a predetermined position on said outer surface of said insert support unit; and
a support part provided on said second end of said insert support unit, said support part being seated in said arc-shaped elastic seat.
